(19) United States
(12) Patent Application Publication
(10) Pub. No.: US 2009/0245581 A1
(43) Pub. Date: Oct. 1, 2009

(54) Airborne terrain acquisition and processing system with fluid detection

(76) Inventor: Sean Dey, New Waterford, OH (US)

Correspondence Address: Harpman & Harpman, 819 Southwestern Run, Youngstown, OH, 44514, US

(21) Appl. No.: 12/079,913

(22) Filed: Mar. 31, 2008

(51) Int. Cl. G06K 9/00

(52) U.S. Cl. 382/104

(57) ABSTRACT

An airborne digital image capture and assessment system for fluid transmission lines having integrated location and event tracking. The system combines a fixed wing aircraft aerial platform, real-time surveying with target fluid detection and real-time threat assessment review by independent reviewing stations. The continuous digital video image capture provides a position indexing database record with the system creating and assigns flight survey routes with GPS position acquisition for pilot acknowledgement and auto pilot integration with route survey completion confirmation. Offsite analysis and review of survey data imaging provides

### BACKGROUND OF THE INVENTION

1. Technical Field

This invention relates to aerial surveillance systems that are used to survey and inspect utility oriented transmission terrain pathways such as power lines and oil and gas transmission lines over a variety of geographical terrain surfaces.

2. Description of Prior Art

The utility transmission industry has always had a need to periodically inspect their transmission lines for safety and minimal regulatory requirements. With current threat possibilities related to supply interruption by domestic or foreign inspired terrorists an increasing need has been mandated by government security agency to provide for better and timelier survey and surveillance of transmission lines. Given the number and diversity of transmission lines and their associated right of ways, current threat assessment including detection and rapid response techniques have been deemed inadequate and will not meet the newly mandated requirements.

Such prior art survey systems include the traditional on the ground observation and aerial survey by employing rotary aircraft such as helicopters and some fixed wing aircraft. Heretofore such survey systems have relied on a patchwork haphazard approach using limited technology integration; see for example U.S. Pat. Nos. 3,940,762, 5,894,323, 6,118,885, 7,095,488 and 7,184,072.

U.S. Pat. No. 3,940,762 is directed to a digital detection control device for surveillance radar with video return detectors.

U.S. Pat. No. 5,894,323 discloses an airborne imaging system using a fixed wing aircraft or a ground vehicle for remote data collection. The system provides for the recording and locating of geographical data for applied application uses.

An airborne image acquisition and processing system is shown in U.S. Pat. No. 6,118,885 having a CCD imaging device to capture multiple strips of overfly ground image data. The system is capable of data acquisition on multiple spectral bands and detection of dissimilar phenomenon such as forest fires and transmission line leaks.

U.S. Pat. No. 7,095,488 is for a system to profile objects on terrain from an aircraft using forward looking cross track laser altimeter.

Finally, in U.S. Pat. No. 7,184,072, claims are directed towards an airborne inventory and inspection system and apparatus to acquire images of electrical transmission line towers and line suspended from the towers. The system calculates the apparatus attenuation line of a still image camera facing rearwardly based on aircraft height, GPS coordinates and angle to line of flight path to capture an optimum image of the transmission tower automatically.

### SUMMARY OF THE INVENTION

The present invention is directed to an integrated aircraft survey system for utility transmission lines by a fixed wing aircraft having a continuous digital video capture camera with GPS navigation interlinked corresponding to a predetermined survey travel path of the utility transmission line. A remote gas laser detection apparatus capable of detecting trace concentration of selected gases in a mixed gas environment is integrated with the video capture recorder and event specific GPS positioning via an onboard electronic data capture for real-time pilot review for access notification investigation and transfer to off site independent review and analysis.

### DESCRIPTION OF THE DRAWINGS

FIG. 1 is a block flow diagram of the onboard craft system hardware components and flow interaction.

FIG. 2 is a process flow overview diagram.

FIG. 3 is a menu overview block flow diagram chart associated therewith.

### DETAILED DESCRIPTION OF THE INVENTION

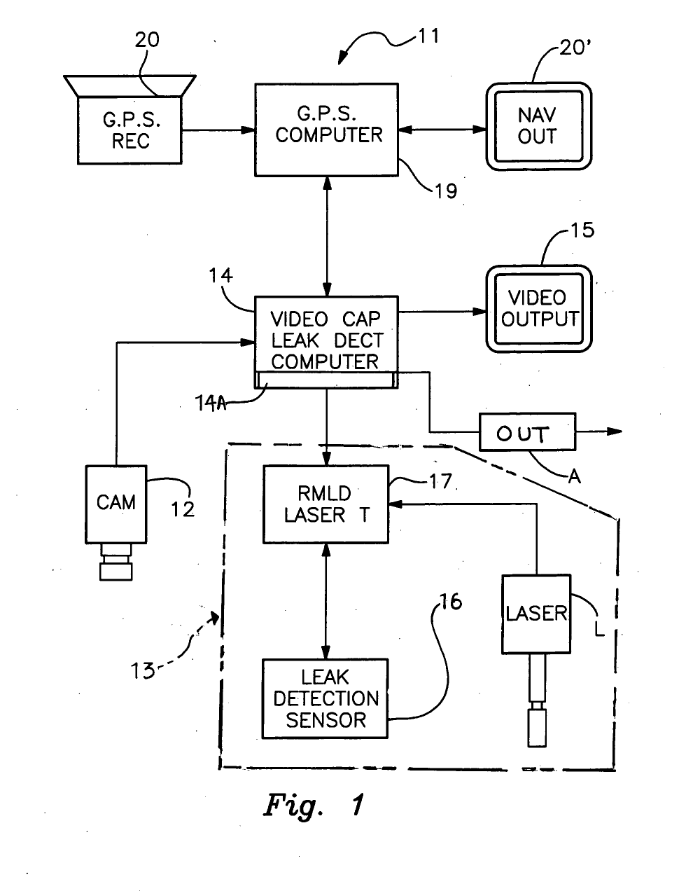

Referring to FIG. 1 of the drawings, a block flow diagram of an onboard aircraft terrain imaging capture and process system of the invention (ATICP) can be seen. The video image capture apparatus includes an airborne data collection platform 11 having (CCD), digital camera 12 or equivalent and laser gas leak detection assembly (LGLD) 13 indicated by inclusive broken lines.

The CCD camera 12 is of a high speed and high resolution digital data camera in communication with and controlled by a proprietary software system packages in a video leak detection onboard computer 14. The computer 14 has a touch sensitive status output screen interface 15 for notification and pilot command input as will be described in greater detail hereinafter.

The laser gas leak detection assembly 13 comprises a commercially available laser L based gas leak detection sensor 16 using tunable diode laser absorption spectroscopy technology known within the art. The return laser light using image magnification lens (not shown) in the process system is analyzed and based on predetermined gas values to be detected by the leak detection sensor 16 in communication with a laser transceiver 17. The leak detection system software residing in the onboard computer 14 which, as noted, is interlinked with the CCD camera 12 that will capture a continuous video record of high resolution video images of the surveyed transmission line path.

The digital video image data is stored directly to a data storage disk 14A for electronic downloading or delayed physical transfer to a remote review and analysis site station as will be described in detail hereinafter.

The ATICP system of the invention has an integrated GPS navigation system computer 19 which receives and processes GPS navigation singles from a GPS receiver 20 calculating location data and provides an available interactive navigation output display interface 20′ for visual and access interpretation by the pilot (not shown).

The critical feature of the ATICP system is the seamless integration and synchronization of the continuous real-time digital video data image stream from the CCD camera 12 with the remote gas leak detection assembly 13 and the GPS navigation location data overlay assuring detailed incident incursion time and position relative the airborne platform survey route will register precisely with the plotted transmission line, as noted.

In operation, the laser gas leak detection assembly 13 provides for the laser L base gas detection of a known hydrocarbon at a predetermined known value and thus can confirm the possible leak from the remote airborne data collection platform and then begins a notification protocol and investigation incident. By combining remote laser gas leak detection technology with visual imaging via the CCD camera 12 of the transmission line from the airborne survey platform with the interface GPS navigation points, the system provides a reviewable and actionable record of the actual transmission line status being surveyed. Given the onsite (air) real-time leak detection, the pilot is notified by audio A out and visual warning alerts with the pilot specific confirmation via the status output screen 15. Such data can automatically or manually be relayed for review or location specific surface action by service and safety personnel (not shown) on the ground for a timely response to such incident incursions, should they arise.

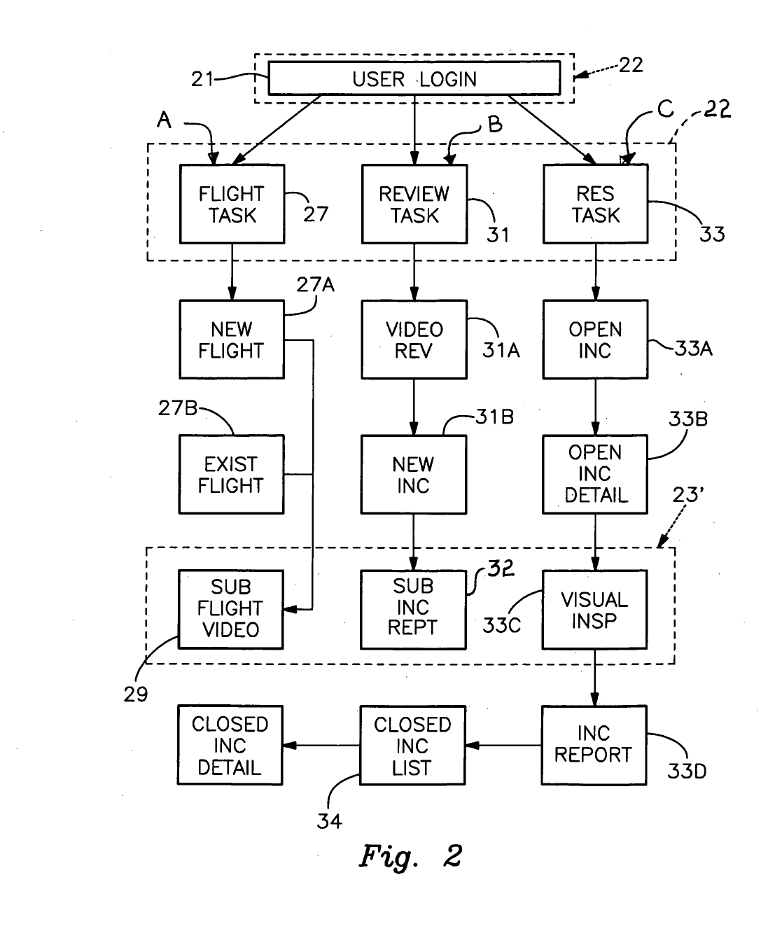

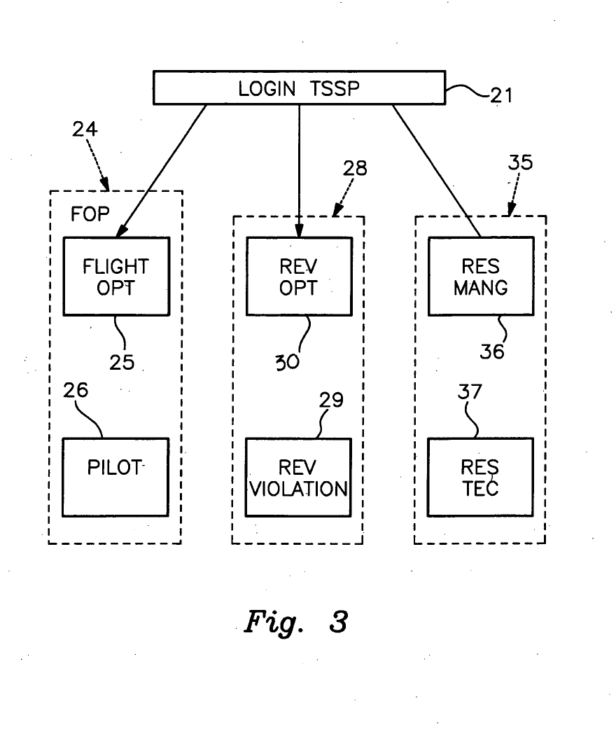

The access overview of surveyed flight data input operation and action menu review is illustrated graphically in FIGS. 2 and 3 of the drawings. A user log input screen 21 indicates the use of a web accessible base secured central server 22 indicated by broken lines for data and operational review access screens 23 of the proprietary operational software of the system.

Referring to FIG. 3 of the drawings, a flight operation phase 24 indicated in dotted lines having a management screen 25 can be seen in which all survey flights are scheduled within the time occurrence compliance and assignment of area surveillance survey routes to the designated pilot. A pilot in charge screen 26 is provided to assure the pilot acknowledgement of the scheduled flight survey and then upon completion notification within the system of compliance of submission of the coded survey data video for independent review.

Referring to FIG. 2 of the drawings, the incident system operational process flow sequence defines three vertical system action steps as illustrated generally as: (A) flight video, (B) video review and (C) incident resolution.

The flight video “A” step is accessed via the user log-on screen 21 and is provided with a flight task menu 27 having sub menus new flight input screens 27A and edit existing flight screens 27B.

Referring now to FIGS. 2 and 3 of the drawings, a review operation phase 28 is illustrated in which the data coding survey video 29 is received for review and uploaded into the central data server under a review operational management screen 30 which is accessed by the hereinbefore described log in screen 21 with the submission of the flight data enhanced video 29 defined in the flight video step “A”.

The video review step “B” illustrated in FIG. 2 of the drawings by an independent review has a review task menu 31 having a video review screen 31A and new incident screen 31B. Video review by the independent reviewer assures quality compliance for overseeing critical review function in which the video record 29 which is encoded with acquisition time and GPS positioning location stamps in systematic review to determine if a physical incursion by non-authorized personnel is occurring or has occurred. Such visual incursion evidence is detected and an incident report 32 is generated with corresponding location and time indexing data and submitted.

The incident resolution step “C” indicated by the resolution task member screen 33 as an active “open” incident report list 33A with corresponding “open” incident details 33B requires a “visual inspection” 33C which required resolution action indicated on the IRS screen 33D.

Upon incident resolution, the incident is submitted to and resides on a closed incident lists 34 with associated incident details indicating action taken and closure outcome.

Referring back to FIG. 3 of the drawings, the resolution operation phase 35 is illustrated with the resolution management screen 36 by which all aspects of the ATICP system of the invention progress can be tracked and coordinated with the hereinbefore described flight operations and review operations for specific information data request, if needed. Resolution access screens 37 for resolution technician is available via system log-on in which a final review of the incident (violation) reports are resolved and provides for audit track for incident report action and solution compliance with contractual guidelines and regulatory compliance requirements.

It will thus be seen that a new and novel airborne terrain image capturing and processing system of the invention has been illustrated and described and it will be apparent to those skilled in the art that various changes and modifications may be made therein without departing from the spirit of the invention.

Therefore I claim:

1. An airborne digital imaging capture system for surveillance of terrestrial transmission lines, said system comprising,
a digital video capture camera, an integrated GPS navigation unit and laser enabled gas detection,
an onboard central processing unit having a removable data memory,
real-time visual display and command interface screen displays,
analysis of captured video data, means for real-time threat assessment and interlink communication with ground base interdiction and means for analysis overview steps of surveillance flight route and third party review and analysis of captured video and gas detection data.

2. The airborne digital imaging capture system set forth in claim 1 wherein said integrated GPS navigation comprises,
a GPS satellite receiver, a GPS navigation computer, and means for synchronizing GPS map coordinates with said continuous digital video capture for position and time encoding thereof.

3. The airborne digital imaging capture system set forth in claim 1 wherein said laser enabled gas detection comprises,
a laser transmitter,
a gas leak detection laser receiving sensor,
an RMLD laser transceiver interfaced with said onboard central processing unit.

4. An airborne digital imaging capture system set forth in claim 1 wherein said real-time visual display and command interface screen display comprises,
a navigation screen, a video capture and leak detection status output screen, a flight operations management screen, a pilot in charge screen, review operations management screen, reviewer and violation report screen, and resolution management screens and resolution technical screens.

5. The airborne digital imaging capture system set forth in claim 1 wherein said means for real-time threat assessment comprises,
visual recognition confirmation user interface screen display and
interlinked position time data transmission to remote ground base action response interdiction units.

6. An airborne system for acquisition and processing of images of a surveyed ground path to detect anomalies including select gas concentrations by remote photo take detection comprises the steps of,
a. scheduling flight route based on transmission line navigation plot data to be surveyed,
b. assigning said flight route to pilot,
c. pilot confirmation of flight route,
d. visual data and gas detection analysis data captured and recording thereof,
e. real-time visual onboard review for current threat assessment,
f. ongoing GPS navigation configuration of flight path and data coding with video and gas detection capture record,
g. pilot communication activation of possible real-time threat to ground base interdiction personnel,
h. pilot confirmation of completed surveillance flight and transfer of recorded captured data for review,
i. off-site remote independent data review for stipulated survey criteria,
j. report action generation of defined criteria violation for review,
k. resolution action, if required, for report violations,
l. report review of violation, resolution actions taken associated therewith and closure residue actions confirmation,
m. resolution management of system process steps including overview coordination of flight operations and archival access reports and special request reports data confirmation survey determination.
